(19) United States
(12) Patent Application Publication
(10) Pub. No.: US 2017/0212471 A1
(43) Pub. Date: Jul. 27, 2017

(54) HOLOGRAM RECORDING DEVICE

(71) Applicant: FUJI XEROX CO., LTD., Tokyo (JP)

(72) Inventors: Yasuhiro OGASAWARA, Kanagawa (JP); Shigetoshi NAKAMURA, Kanagawa (JP); Jiro MINABE, Kanagawa (JP)

(73) Assignee: FUJI XEROX CO., LTD., Tokyo (JP)

(21) Appl. No.: 15/227,075

(22) Filed: Aug. 3, 2016

(30) Foreign Application Priority Data
Jan. 21, 2016 (JP) 2016-009528

(51) Int. Cl. G03H 1/04; G03H 1/26

(52) U.S. Cl. CPC G03H 1/0406; G03H 1/2645; G03H 1/268; G03H 2001/266; G03H 2223/24; G03H 2227/03; G03H 2222/18

(57) ABSTRACT

A hologram recording device includes a light outputting unit that sequentially outputs multiple laser beams such that the laser beams are coaxially aligned, the laser beams having different wavelengths and being emitted from multiple laser beam sources, an optical system that generates a reference beam and an object beam, with which a hologram is recorded, from each of the laser beams output from the light outputting unit, and an adjusting unit that adjusts a relative position of a recording medium and a focus position of the object beam generated from each of the laser beams having different wavelengths so that the object beam is focused on a surface of the recording medium when the hologram recording device records multiple holograms in a wavelength multiplex recording by sequentially applying the object beams and the reference beams to the recording medium.

### CROSS-REFERENCE TO RELATED APPLICATIONS

This application is based on and claims priority under 35 USC 119 from Japanese Patent Application No. 2016-009528 filed Jan. 21, 2016.

### BACKGROUND

### Technical Field

The present invention relates to a hologram recording device.

### SUMMARY

A hologram recording device according to an aspect includes a light outputting unit that sequentially outputs multiple laser beams such that the laser beams are coaxially aligned, the laser beams having different wavelengths and being emitted from multiple laser beam sources; an optical system that generates a reference beam and an object beam, with which a hologram is recorded, from each of the laser beams output from the light outputting unit; and an adjusting unit that adjusts a relative position of a recording medium and a focus position of the object beam generated from each of the laser beams having different wavelengths so that the object beam is focused on a surface of the recording medium when the hologram recording device records multiple holograms in a wavelength multiplex recording by sequentially applying the object beams and the reference beams to the recording medium.

### BRIEF DESCRIPTION OF THE DRAWINGS

Exemplary embodiments of the present invention will be described in detail based on the following figures, wherein:

FIGS. 1A and 1B are schematic diagrams of an example of original images;

FIG. 2 is a schematic diagram for illustrating the principle of a holographic stereogram;

FIG. 3 is a configuration diagram of an example of a configuration of a hologram recording device according to a first exemplary embodiment of the present invention;

FIG. 4 is a block diagram of an example of an electronic configuration of the hologram recording device illustrated in FIG. 3;

FIGS. 5A and 5B are schematic diagrams for illustrating an adjustment of the position of an objective lens;

FIG. 6 is a configuration diagram of an example of a configuration of a hologram recording device according to a second exemplary embodiment of the present invention;

FIG. 7 is a schematic diagram for illustrating an adjustment of the position of a recoding medium;

FIG. 8 is a configuration diagram of an example of a configuration of a hologram recording device according to a third exemplary embodiment of the present invention; and

FIGS. 9A to 9C are schematic diagrams for illustrating an adjustment of the position of a relay lens.

### DETAILED DESCRIPTION

Referring now to the drawings, exemplary embodiments of the invention are described in detail below.

### Principle of Holographic Stereogram

Now, the principle of a holographic stereogram is described first.

One way of displaying a three-dimensional image is a holographic stereogram. A holographic stereogram is produced by acquiring two-dimensional images of an object photographed from different viewpoints slightly shifted from one another as original images, reconstructing the acquired multiple original images to generate multiple display images that are displayed on a display device, and sequentially recording the generated multiple display images on one hologram recording medium as multiple holographic elements. In the following description, original images and display images are collectively referred to as “parallax images”.

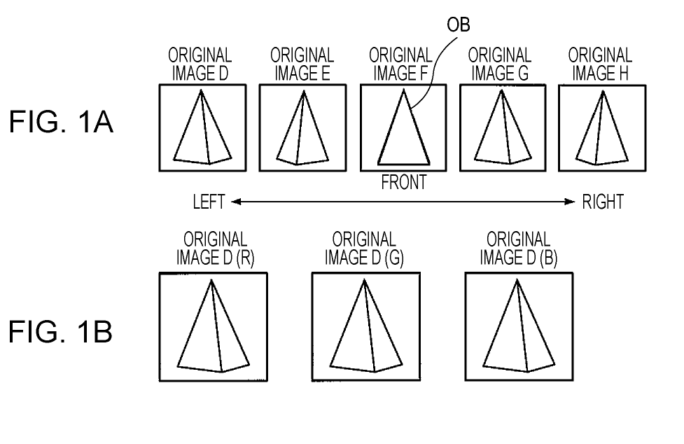

FIG. 1A is a schematic diagram of an example of original images. In this example, a quadrangular pyramid is used as an object OB and the object OB is photographed from different viewpoints slightly shifted from one another in the horizontal direction. An image of the object OB photographed from the front is an original image F. An image of the object OB photographed from obliquely left in the horizontal direction is an original image E and an image of the object OB photographed from a position rotated further leftward from the position at which the original image E is photographed is an original image D. An image of the object OB photographed from obliquely right in the horizontal direction is an original image G and an image of the object OB photographed from a position rotated further rightward from the position at which the original image G is photographed is an original image H. As illustrated in FIG. 1B, in the case of forming a full-color holographic stereogram, an original image of red (R), an original image of green (G), and an original image of blue (B) are generated from each of the original images D, E, F, and G.

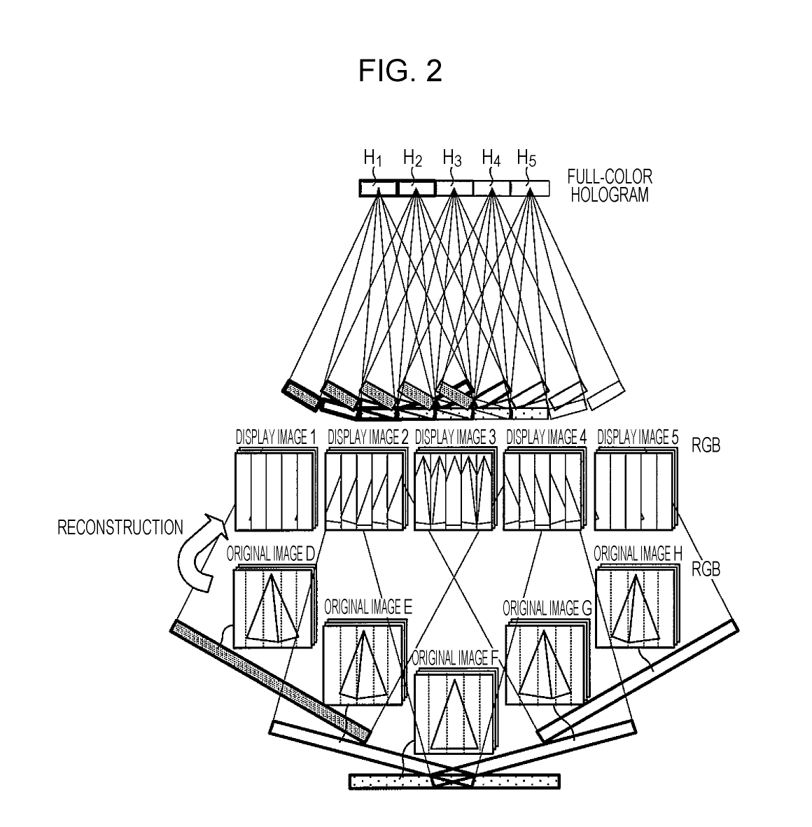

FIG. 2 is a schematic diagram illustrating the principle of a holographic stereogram. For example, to form a holographic stereogram having horizontal parallax information, an object OB is sequentially photographed from different viewpoints slightly shifted from one another in the horizontal direction as illustrated in FIG. 2, so that the original images D, E, F, G, and H are acquired. Each of the original images D to H is separated by colors to generate R, G, and B original images.

Subsequently, these original images D to H are reconstructed per color to generate display images 1, 2, 3, 4, and 5. In the case of forming a full-color holographic stereogram, red (R) display images 1R, 2R, 3R, 4R, and 5R are generated from red (R) original images of the original images D to H, green (G) display images 1G, 2G, 3G, 4G, and 5G are generated from green (G) original images of the original images D to H, and blue (B) display images 1B, 2B, 3B, 4B, and 5B are generated from blue (B) original images of the original images D to H. Unless red (R), green (G), and blue (B) need to be distinguished from one another, these display images are collectively referred to as display images 1, 2, 3, 4, and 5.

In this example, each original image is divided into five segments in the horizontal direction and then an image acquired by arranging n-th (n is an integer from one to five) pixel columns of the original images D to H from the left in this order serves as a display image n. Then, display images 1 to 5 are sequentially recorded on a hologram recording medium as strip-shaped holographic elements H1, H2, H3, H4, and H5.

In a full-color holographic stereogram, R, G, and B display images are recorded on one holographic element in a wavelength multiplex recording using laser beams of different wavelengths corresponding to R, G, and B. For example, what is obtained by sequentially recording a hologram on which R display images 1R are recorded, a hologram on which G display images 1G are recorded, and a hologram on which B display images 1B are recorded in a wavelength multiplex recording in the same region serves as a holographic element H1. The order in which a recording medium is exposed to R, G, and B light beams are not limited to the described order.

Image surfaces of the original images D to H correspond to a surface of the hologram recording medium constituted of the holographic elements H1 to H5. The converging angles of the display images 1 to 5 correspond to observation angles at which an observer observes the hologram recording medium. Specifically, angle dependence information of each pixel column of the display image is recorded. Thus, by reproducing the holographic elements H1 to H5, the entirety of the hologram (that is, the original images D to H) is reproduced, whereby a three-dimensional image of the object OB is recognized by an observer. In the case where the hologram is a full-color holographic stereogram, a full-color three-dimensional image is recognized by an observer.

In this exemplary embodiment, when a full-color holographic stereogram is to be formed, optical axes of three-color laser beams output from the R, G, and B laser beam sources are superimposed together so as to be coaxially aligned with one another using optical devices such as dichroic mirrors. Thus, a common optical system and a common spatial light modulator (SLM) are usable to record three holograms corresponding to three colors of R, G, and B with the R, G, and B laser beams in a wavelength multiplex recording on a holographic element.

The use of the common optical system and the common spatial light modulator, however, may vary the focus position of the object beams of the R, G, and B laser beams and vary the size of three holograms corresponding to the three colors of R, G, and B recorded in a wavelength multiplex recording. Thus, in this exemplary embodiment, the positional relationship between the recording medium and the focus position of the object beam of each of the R, G, and B laser beams is adjusted so that the object beam is focused on the surface of the recording medium.

### First Exemplary Embodiment

### Hologram Recording Device

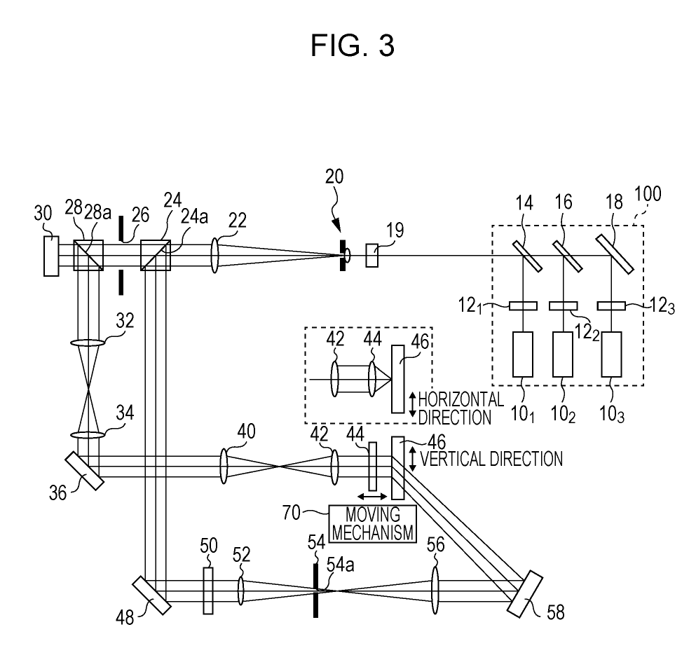

The following describes a device that forms a holographic stereogram (the device is hereinafter simply referred to as a “hologram recording device”). FIG. 3 is a configuration diagram of an example of the configuration of a hologram recording device according to a first exemplary embodiment of the present invention. In this exemplary embodiment, a hologram recording device that forms holographic stereograms having horizontal parallax information is described. FIG. 3 is a top view of the hologram recording device.

As illustrated in FIG. 3, the hologram recording device includes, for use as a light outputting unit, a laser-beam emitting portion 100 that sequentially emits multiple laser beams having different wavelengths by switching multiple laser beam sources 10 one to another while the laser beams are coaxially aligned. The laser-beam emitting portion 100 includes a first laser beam source 10₁, a second laser beam source 10₂, a third laser beam source 10₃, shutters 12₁, 12₂, and 12₃ provided so as to correspond to the respective laser beam sources 10₁, 10₂, and 10₃, a first optical device 14 provided so as to correspond to the first laser beam source 10₁, a second optical device 16 provided so as to correspond to the second laser beam source 10₂, and a mirror 18 provided so as to correspond to the third laser beam source 10₃.

The laser beam source 10₁, the second laser beam source 10₂, and the third laser beam source 10₃ are laser beam sources that emit laser beams of different wavelengths. Examples usable as the laser beam sources include a semiconductor-excited solid-state laser. Unless the laser beam sources need to be distinguished from one another, they are collectively referred to as laser beam sources 10.

The shutters 12₁, 12₂, and 12₃ are provided on the light emission side of the corresponding laser beam sources 10 so as to be interposable into the optical paths of the laser beams or so as to be retractable from the optical paths. When closed, the shutters 12₁, 12₂, and 12₃ are interposed into the optical paths to block the laser beams. When opened, the shutters 12₁, 12₂, and 12₃ are retracted from the optical paths to allow the laser beams to pass thereby. As described below, the R, G, and B laser beams are sequentially emitted in a time division manner. Only a shutter 12 corresponding to the laser beam source 10 that emits a laser beam is opened to allow the laser beam to pass thereby. Unless the shutters 12₁, 12₂, and 12₃ need to be distinguished from one another, they are collectively referred to as shutters 12.

Each of the first optical device 14 and the second optical device 16 is an optical device that transmits a laser beam incident thereon in the optical axis direction, reflects in the optical axis direction a laser beam incident thereon in a direction that crosses the optical axis direction, and aligns together the optical axes of the laser beams incident thereon in two directions. Examples usable as an optical device for optical axis alignment include a dichroic mirror and a polarization beam splitter.

The first optical device 14 reflects in the optical axis direction a laser beam incident thereon in a first direction and transmits and outputs a laser beam incident thereon in the optical axis direction. The second optical device 16 reflects in the optical axis direction a laser beam incident thereon in a second direction to cause the laser beam to enter the first optical device 14, and allows a laser beam incident thereon in the optical axis direction to pass therethrough to cause the laser beam to enter the first optical device 14.

In this exemplary embodiment, the first laser beam source 10₁ applies a laser beam to the first optical device 14 in the first direction. The second laser beam source 10₂ applies a laser beam to the second optical device 16 in the second direction. The third laser beam source 10₃ applies a laser beam to the second optical device 16 in the optical axis direction.

A laser beam emitted from the third laser beam source 10₃ is reflected by the mirror 18 in the optical axis direction and incident on the second optical device 16 in the optical axis direction. Then, the laser beam passes through the second optical device 16 and the first optical device 14 and is output from the laser-beam emitting portion 100.

A laser beam emitted from the second laser beam source 10₂ is reflected by the second optical device 16 in the optical axis direction, aligned so as to be coaxial with the laser beam emitted from the third laser beam source 10₃, and then incident on the first optical device 14 in the optical axis direction. Thereafter, the laser beam passes through the first optical device 14 and is output from the laser-beam emitting portion 100.

A laser beam emitted from the first laser beam source 10₁ is reflected by the first optical device 14 in the optical axis direction, aligned so as to be coaxial with the laser beam emitted from the third laser beam source 10₃ and the laser beam emitted from the second laser beam source 10₂, and output from the laser-beam emitting portion 100.

In this exemplary embodiment, the first laser beam source 10₁ represents a blue (B) laser beam source that emits blue laser beams of a wavelength of 473 nanometers (nm). The second laser beam source 10₂ represents a red (R) laser beam source that emits red laser beams of a wavelength of 640 nm. The third laser beam source 10₃ represents a green (G) laser beam source that emits green laser beams of a wavelength of 532 nm. Here, the wavelength of each laser beam source is specified for illustration purpose and the laser beam sources are not limited to the above-described sources. The correspondence between the colors of R, G, and B and the first laser beam source 10₁, the second laser beam source 10₂, and third laser beam source 10₃ is specified for illustration purpose and may be different.

The laser-beam emitting portion 100 having the above-described configuration sequentially switches the first laser beam source 10₁, the second laser beam source 10₂, and the third laser beam source 10₃ one to another to sequentially emit R, G, and B laser beams in a time division manner. The laser beam sources 10 are switched one to another by opening and closing the corresponding shutters 12. Three holograms corresponding to the three colors of R, G, and B are recorded using the R, G, and B laser beams in a wavelength multiplex recording on a holographic element.

On the light emission side of the laser-beam emitting portion 100, a half-wave plate 19, a spatial filter 20, a lens 22, and a polarization beam splitter 24 are provided in this order from the laser-beam emitting portion 100 along the optical path. The half-wave plate 19 adjusts the intensity ratio of an object beam to a reference beam by rotating a plane of polarization of incoming light. The spatial filter 20 and the lens 22 collimate the beam that has passed through the half-wave plate 19 and allow the collimated beam to enter the polarization beam splitter 24.

The polarization beam splitter 24 includes a reflecting surface 24a that transmits p-polarized light but reflects s-polarized light. The polarization beam splitter 24 splits the laser beam into an object beam and a reference beam. The light transmitted through the polarization beam splitter 24 serves as the object beam (p-polarized light). The light reflected by the polarization beam splitter 24 serves as the reference beam (s-polarized light).

An optical system that generates an object beam is described first. On the light transmission side of the polarization beam splitter 24, a slit 26 and a polarization beam splitter 28 are provided in this order from the polarization beam splitter 24 along the optical path. The slit 26 shapes the object beam (p-polarized beam) into a rectangle and allows the rectangular beam to enter the polarization beam splitter 28. The polarization beam splitter 28 includes a reflecting surface 28a that transmits p-polarized beams but reflects s-polarized beams.

A reflective display device 30 is provided on a transmitted-light side of the polarization beam splitter 28. The display device 30 includes plural pixels and displays an image based on image information by modulating at least one of the amplitude, the phase, and the direction of polarization of incoming light for each of the pixels. The display device 30 may be, for example, a spatial light modulator. In the present exemplary embodiment, a reflective liquid crystal on silicon (LCOS) is employed as the display device 30, and an image is displayed on a display area of the LCOS.

The object beam is modulated and reflected by the display device 30, whereby an object beam to be used for recording a hologram is generated. More specifically, when the object beam in the form of the p-polarized light is reflected by the display device 30, the object beam is converted into s-polarized light. Then, the s-polarized light serving as the object beam enters the polarization beam splitter 28 again and is reflected by the reflecting surface 28a of the polarization beam splitter 28.

A lens 32, a lens 34, and a mirror 36 are provided in that order on a reflected-light side of the polarization beam splitter 28 along the optical path after the polarization beam splitter 28. The object beam reflected by the polarization beam splitter 28 is relayed by the lens 32 and the lens 34 and is applied to the mirror 36. The mirror 36 redirects the optical path of the object beam toward a hologram recording medium 46.

A lens 40, a lens 42, and a condensing lens 44 are provided in that order along the optical path between the mirror 36 and the hologram recording medium 46. The condensing lens 44 is a cylindrical lens or the like that condenses incoming light only in a one-dimensional direction (the horizontal direction). In this exemplary embodiment, the condenser lens 44 is moved by a moving mechanism 70 in the optical axis direction indicated by arrow so that each object beam is focused on the surface of the hologram recording medium 46. Here, the “optical axis direction” is a direction in which the optical axis extends. The condenser lens 44 opposing the hologram recording medium 46 corresponds to an “objective lens”.

In FIG. 3, the direction orthogonal to the plane of the page corresponds to the horizontal direction, and the direction parallel to the plane of the page corresponds to the vertical direction. Each strip-shaped or substantially strip-shaped holographic element is recorded such that the long-side direction thereof corresponds to the vertical direction and the short-side direction thereof corresponds to the horizontal direction. The hologram recording medium 46 is held by a holding member (not illustrated) and is moved in the horizontal direction by a moving device (not illustrated) after every recording of a holographic element.

The object beam reflected by the mirror 36 is relayed by the lenses 40 and 42, condensed only in the horizontal direction by the condensing lens 44, and is applied to the hologram recording medium 46. The way the object beam is condensed only in the horizontal direction is illustrated as a side view enclosed by the broken line in FIG. 3.

Now, an optical system that generates the reference beam will be described. A mirror 48, a slit 50, a lens 52, a douser 54 having an aperture 54a, a lens 56, and a mirror 58 are provided in that order on a reflected-light side of the polarization beam splitter 24 along the optical path after the polarization beam splitter 24. The mirror 48 redirects the optical path of the reference beam toward the mirror 58.

The slit 50 shapes the reference beam into a rectangular beam and allows the rectangular beam to enter the lens 52. The reference beam having entered the lens 52 is relayed and broadened by the lens 52 and the lens 56, respectively, while passing through the aperture 54a before being applied to the mirror 58. The aperture 54a is provided at the focal position between the lens 52 and the lens 56.

The mirror 58 reflects the reference beam transmitted through the lens 56 and redirects the optical path of the reference beam toward the hologram recording medium 46. In the present exemplary embodiment, the reference beam is applied to the hologram recording medium 46 from a side different from the side of application of the object beam to the hologram recording medium 46. The reference beam is applied to the hologram recording medium 46 such that the optical axis thereof intersects the optical axis of the object beam in the hologram recording medium 46. The above optical systems are only exemplary, and some of the lenses, mirrors, and other elements may be omitted, or other elements may be added thereto, according to design need. Electric Configuration of Hologram Recording Device

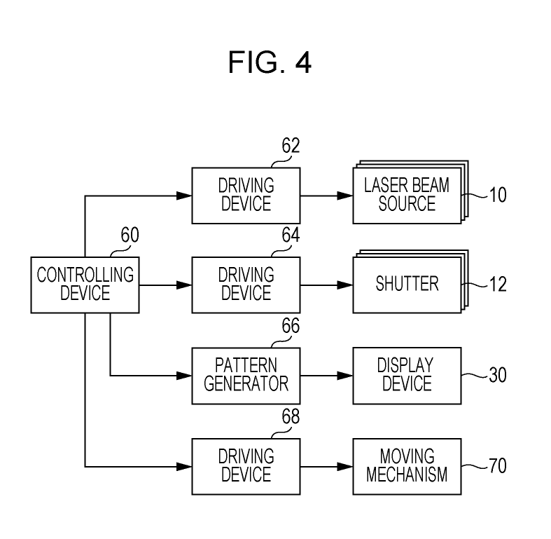

Subsequently, an electric configuration of the hologram recording device is described. FIG. 4 is a block diagram of an example of an electric configuration of the hologram recording device illustrated in FIG. 3. The hologram recording device includes a controlling device 60 that controls the entirety of the device. The controlling device 60 is formed of a computer and includes a central processing unit (CPU), a read only memory (ROM) that stores various programs, a random access memory (RAM) that is used as a work area in the execution of the programs, and a nonvolatile memory that stores various types of information.

The laser beam sources 10 are connected to the controlling device 60 with a driving device 62 interposed therebetween. The driving device 62 turns on the laser beam sources 10 in response to commands from the controlling device 60. The shutters 12 are also connected to the controlling device 60 with a driving device 64 interposed therebetween. The driving device 64 opens and closes the shutters 12 in response to commands from the controlling device 60.

The display device 30 is also connected to the controlling device 60 with a pattern generator 66 interposed therebetween. The pattern generator 66 generates patterns in accordance with image information supplied from the controlling device 60. Multiple pixels of the display device 30 modulate incident light in accordance with the patterns, so that images corresponding to the image information are displayed.

In this exemplary embodiment, the moving mechanism 70 that moves the condenser lens 44 is connected to the controlling device 60 with a driving device 68 interposed therebetween. The driving device 68 drives the moving mechanism 70 on the basis of a command from the controlling device 60.

Now, the hologram recording process is described. In this exemplary embodiment, G, R, and B laser beams are emitted in this order so that three holograms corresponding to the three colors of R, G, and B are recorded in a wavelength multiplex recording with the R, G, and B laser beams on a holographic element. The shutters 12 are closed until they are driven to be open.

The driving device 62 turns on the first laser beam source 10₁, the second laser beam source 10₂, and the third laser beam source 10₃. The driving device 64 opens the shutter 12₃ first to allow a green laser beam to pass thereby. Thus, the green laser beam is applied from the third laser beam source 10₃. Concurrently, the controlling device 60 supplies green image information to the pattern generator 66, causes the display device 30 to display a green display image at a predetermined timing, and records the green display image on the hologram recording medium 46 for use as a hologram.

Specifically, the green laser beam emitted from the third laser beam source 10₃ is reflected by the mirror 18, passes through the second optical device 16 and the first optical device 14, and is output from the laser-beam emitting portion 100. The green laser beam output from the laser-beam emitting portion 100 is incident on the half-wave plate 19, where the plane of the polarization of the laser beam is rotated, is collimated by the spatial filter 20 and the lens 22, is incident on the polarization beam splitter 24, and is split into light for an object beam (p-polarized beam) and light for a reference beam (s-polarized beam).

The green laser beam (p-polarized beam) that has passed through the polarization beam splitter 24 passes through the optical system that generates object beams and is changed into an object beam modulated in accordance with a green display image displayed on the display device 30. On the other hand, the green laser beam (s-polarized beam) reflected by the polarization beam splitter 24 passes through the optical system that generates reference beams and is changed into a reference beam. The object beam and the reference beam generated from the green laser beam are simultaneously applied to the hologram recording medium 46. With interference between the object beam and the reference beam, a green component of a holographic element is recorded.

Subsequently, the driving device 64 closes the shutter 12₃ and opens the shutter 12₂ to allow a red laser beam to pass thereby. Thus, the red laser beam is applied from the second laser beam source 10₂. Concurrently, the controlling device 60 supplies red image information to the pattern generator 66, causes the display device 30 to display a red display image at a predetermined timing, and records the red display image on the hologram recording medium 46 for use as a hologram.

The red laser beam emitted from the second laser beam source 10₂ is reflected by the second optical device 16, aligned so as to be coaxial with the green laser beam, transmitted through the first optical device 14, and output from the laser-beam emitting portion 100. An object beam and a reference beam are generated from the red laser beam in the same manner as in the case of the green laser beam except for this process. The object beam and the reference beam generated from the red laser beam are simultaneously applied to the hologram recording medium 46. With interference between the object beam and the reference beam, a red component of the holographic element is recorded.

Subsequently, the driving device 64 closes the shutter 12₂ and opens the shutter 12₁ to allow a blue laser beam to pass thereby. Thus, the blue laser beam is applied from the first laser beam source 10₁. Concurrently, the controlling device 60 supplies blue image information to the pattern generator 66, causes the display device 30 to display a blue display image at a predetermined timing, and records the blue display image on the hologram recording medium 46 for use as a hologram.

The blue laser beam emitted from the first laser beam source 10₁ is reflected by the first optical device 14, aligned so as to be coaxial with the green and red laser beams, and output from the laser-beam emitting portion 100. An object beam and a reference beam are generated from the blue laser beam in the same manner as in the case of the green laser beam except for this process. The object beam and the reference beam generated from the blue laser beam are simultaneously applied to the hologram recording medium 46. With interference between the object beam and the reference beam, a blue component of the holographic element is recorded.

As described above, multiple holograms corresponding to the red, green, and blue display images are recorded in a wavelength multiplex recording with the red, green, and blue laser beams. Thus, a holographic element of a full-color holographic stereogram is recorded. In addition, by moving the hologram recording medium 46 in the horizontal direction, multiple holographic elements are sequentially recorded on the hologram recording medium 46 so as to be arranged in the horizontal direction.

### Objective Lens Position Adjustment

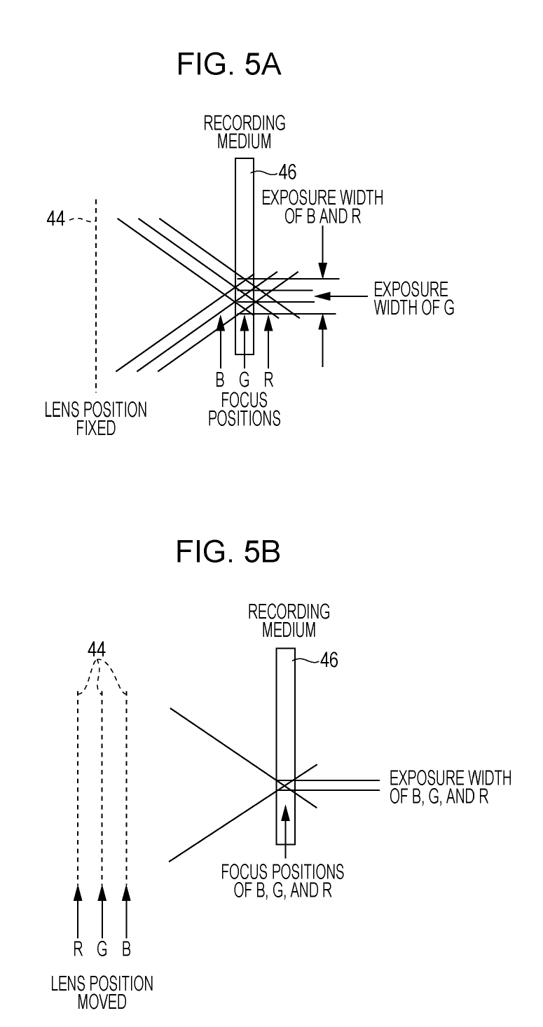

Now, an adjustment of the position of the objective lens is described. FIGS. 5A and 5B are schematic diagrams for illustrating an adjustment of the position of the objective lens. In this exemplary embodiment, as described above, the blue laser beam emitted from the first laser beam source 10₁, the red laser beam emitted from the second laser beam source 10₂, and the green laser beam emitted from the third laser beam source 10₃ are coaxially aligned so that a common optical system and a common spatial light modulator (SLM) are used.

The use of the common optical system and the common spatial light modulator, however, may vary the refractive index of the lens for the R, G, and B laser beams and vary the focus positions of the object beams, as illustrated in FIG. 5A. This variance may vary the size of the three holograms corresponding to the three colors of R, G, and B recorded in a wavelength multiplex recording. For example, as illustrated, the exposure width of the blue or red object beam in the horizontal direction is wider than the exposure width of the green object beam in the horizontal direction.

Thus, in this exemplary embodiment, the position of the condenser lens 44, which is an objective lens, is adjusted so that the object beams of the R, G, and B laser beams are focused on the surface of the hologram recording medium 46, as illustrated in FIG. 5B. By moving the condenser lens 44 in the optical axis direction, indicated with arrow, using the moving mechanism 70, the focus position of each object beam is moved.

If, for example, the position of the objective lens is unadjusted, a blue object beam is focused at a position in front of the hologram recording medium 46. Thus, the condenser lens 44 is moved toward the hologram recording medium 46 so that the blue object beam is focused on the surface of the hologram recording medium 46. If the position of the objective lens is unadjusted, the red object beam is focused at the position beyond the hologram recording medium 46. Thus, the condenser lens 44 is moved away from the hologram recording medium 46 so that the red object beam is focused on the surface of the hologram recording medium 46.

In this exemplary embodiment, by adjusting the position of the condenser lens 44, which is an objective lens, the object beam of each of the R, G, and B laser beams is focused on the surface of the hologram recording medium 46. Thus, the R, G, and B holograms recorded in a wavelength multiplex recording are uniformly sized.

### Second Exemplary Embodiment

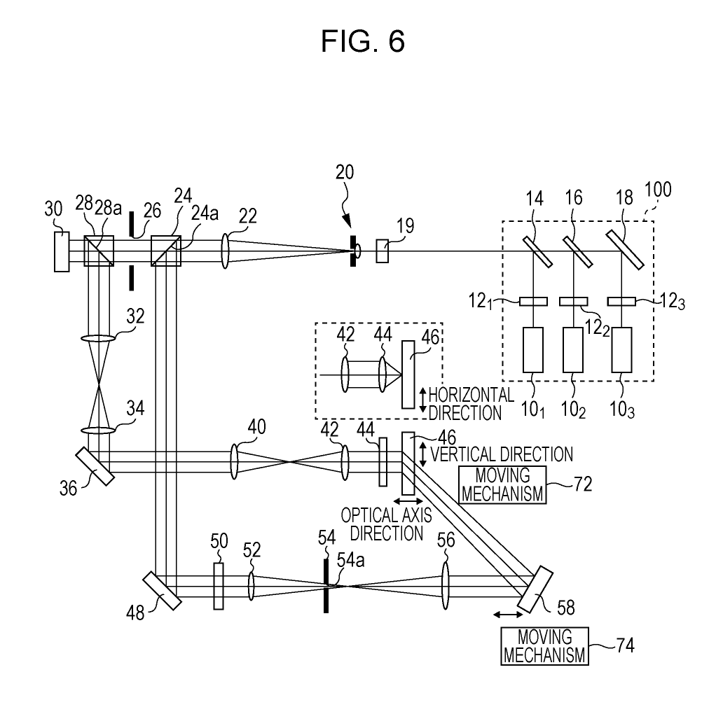

In the first exemplary embodiment, the position of the objective lens is adjusted. In the second exemplary embodiment, on the other hand, the position of the recording medium is adjusted. FIG. 6 is a configuration diagram of an example of a configuration of a hologram recording device according to a second exemplary embodiment of the present invention.

As illustrated in FIG. 6, the hologram recording device according to the second exemplary embodiment has a configuration similar to the configuration of the hologram recording device according to the first exemplary embodiment except that a moving mechanism 72 and a moving mechanism 74 are provided instead of the moving mechanism 70 that moves the condenser lens 44. The moving mechanism 72 holds and moves the hologram recording medium 46. The moving mechanism 74 linearly moves the mirror 58, which reflects the reference beam toward the hologram recording medium 46. The same components are denoted with the same reference symbols and not described.

Although not illustrated, in this exemplary embodiment, the moving mechanism 72 and the moving mechanism 74 are connected to the controlling device 60 with driving devices interposed therebetween, which are not illustrated. The driving devices, not illustrated, drive the moving mechanism 72 and the moving mechanism 74 in response to commands from the controlling device 60.

### Recording Medium Position Adjustment

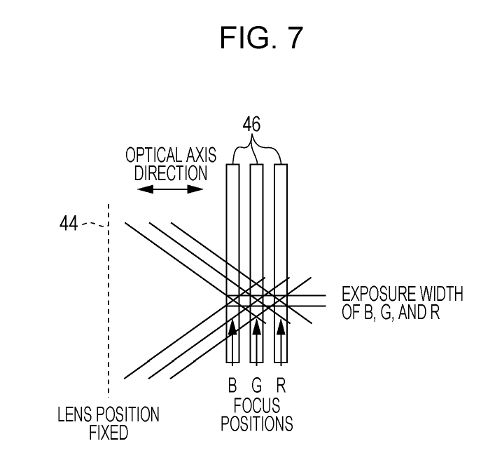

Now, an adjustment of the position of a recording medium is described. FIG. 7 is a schematic diagram for illustrating an adjustment of the position of a recording medium 46. As illustrated in FIG. 7, in this exemplary embodiment, the position of the hologram recording medium 46 is adjusted so that the object beams of the R, G, and B laser beams are focused on the surface of the hologram recording medium 46. The recording medium is moved to the focus position of each object beam by moving the hologram recording medium 46 using the moving mechanism 72 in the optical axis direction, indicated with arrow. Here, the hologram recording medium 46 is held by a holding device, not illustrated, and moved by a moving device, not illustrated, in the horizontal direction. However, the hologram recording medium 46 may be moved in the optical axis direction by this moving device, not illustrated.

If, for example, the position of the recording medium is unadjusted, the blue object beam is focused at a position in front of the hologram recording medium 46. Thus, the hologram recording medium 46 is moved toward the condenser lens 44 so that the blue object beam is focused on the surface of the hologram recording medium 46. If, for example, the position of the recording medium is unadjusted, the red object beam is focused at a position beyond the hologram recording medium 46. Thus, the hologram recording medium 46 is moved away from the condenser lens 44 so that the red object beam is focused on the surface of the hologram recording medium 46.

With a change of the position of the hologram recording medium 46, the direction in which the reference beam is applied is preferably changed at the same time. Thus, in this exemplary embodiment, the moving mechanism 74 linearly moves the mirror 58, as indicated with arrow, so that the reference beam is reflected toward the hologram recording medium 46.

In this exemplary embodiment, the object beams of the R, G, and B laser beams are focused on the surface of the hologram recording medium 46 by adjusting the position of the hologram recording medium 46. Thus, the R, G, and B holograms recorded in a wavelength multiplex recording are uniformly sized.

### Third Exemplary Embodiment

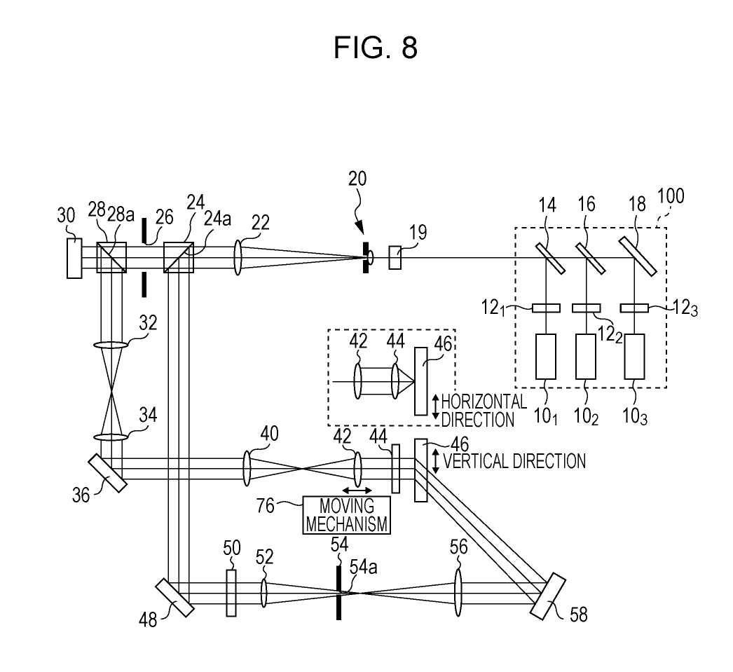

In the first exemplary embodiment, the position of each objective lens is adjusted. In the third exemplary embodiment, on the other hand, the position of the relay lens that applies collimated light to the objective lens is adjusted. FIG. 8 is a configuration diagram of an example of the configuration of a hologram recording device according to the third exemplary embodiment of the present invention.

As illustrated in FIG. 8, the hologram recording device according to the third exemplary embodiment has a configuration similar to the configuration of the hologram recording device according to the first exemplary embodiment except that a moving mechanism 76 is provided instead of the moving mechanism 70, which moves the condenser lens 44. The moving mechanism 76 moves the lens 42, which applies collimated light to the condenser lens 44. The same components are denoted with the same reference symbols and not described.

Although not illustrated, in this exemplary embodiment, the moving mechanism 76 is connected to the controlling device 60 with a driving device interposed therebetween, not illustrated. The driving device, not illustrated, drives the moving mechanism 76 in response to commands from the controlling device 60.

### Relay Lens Position Adjustment

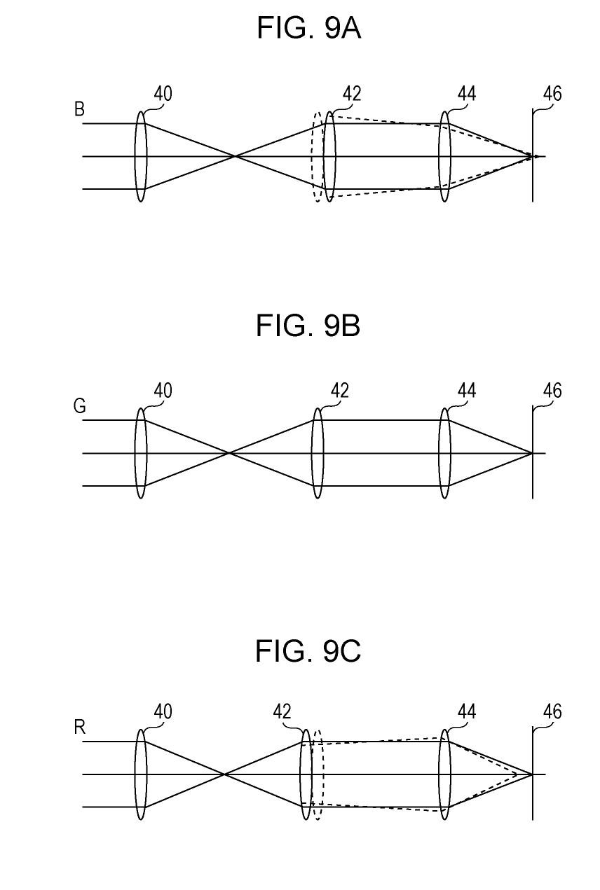

Now, an adjustment of the position of the relay lens is described. FIGS. 9A to 9C are schematic diagrams for illustrating an adjustment of the position of the relay lens 42. As illustrated in FIGS. 9A to 9C, in this exemplary embodiment, the position of the lens 42, which is a relay lens, is adjusted so that the object beams of the R, G, and B laser beams are focused on the surface of the hologram recording medium 46. The focus position of each object beam is moved by moving the lens 42 in the optical axis direction, indicated with arrow, using the moving mechanism 76.

If, for example, the position of the relay lens is unadjusted, the blue object beam is focused at a position in front of the hologram recording medium 46. Thus, the lens 42 is moved toward the hologram recording medium 46 so that the blue object beam is focused on the surface of the hologram recording medium 46. If the position of the objective lens is unadjusted, the red object beam is focused at a position beyond the hologram recording medium 46. Thus, the lens 42 is moved away from the hologram recording medium 46 so that the red object beam is focused on the surface of the hologram recording medium 46.

In this exemplary embodiment, the object beams of the R, G, and B laser beams are focused on the surface of the hologram recording medium 46 by adjusting the position of the lens 42, which is a relay lens. Thus, the R, G, and B holograms recorded in a wavelength multiplex recording are uniformly sized.

### Modification Example

The configuration of the hologram recording device according to each exemplary embodiment is merely an example. The configuration may naturally be changed within a range not departing from the gist of the invention. For example, the invention is applicable to manufacturing of a parallax holographic stereogram that has parallax information in the horizontal direction and the vertical direction by modifying part of the configuration of the hologram recording device.

In each exemplary embodiment, the position of the objective lens, the position of the recording medium, and the position of the relay lens are separately adjusted. However, as long as the object beams of the R, G, and B laser beams are allowed to be focused on the surface of the hologram recording medium 46, two or more positions selected from the position of the objective lens, the position of the recording medium, and the position of the relay lens may be collectively adjusted.

In each exemplary embodiment, the focus position of each object beam is adjusted by moving the objective lens or the relay lens. However, the focus position of each object beam may be adjusted by a focus-adjustable optical system that does not involve movement. Examples of such a focus-adjustable optical system include an electrically focus tunable lens capable of changing the curvature of the lens.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A hologram recording device, comprising:
a light outputting unit that sequentially outputs a plurality of laser beams such that the laser beams are coaxially aligned, the laser beams having different wavelengths and being emitted from a plurality of laser beam sources;
an optical system that generates a reference beam and an object beam, with which a hologram is recorded, from each of the laser beams output from the light outputting unit; and
an adjusting unit that adjusts a relative position of a recording medium and a focus position of the object beam generated from each of the plurality of laser beams having different wavelengths so that the object beam is focused on a surface of the recording medium when the hologram recording device records a plurality of holograms in a wavelength multiplex recording by sequentially applying the object beams and the reference beams to the recording medium.

2. The hologram recording device according to claim 1,
wherein the optical system includes an objective lens that applies the object beams to the recording medium,
wherein the adjusting unit includes a first moving mechanism that moves the objective lens, and
wherein the first moving mechanism adjusts a position of the objective lens in an optical axis direction.

3. The hologram recording device according to claim 1,
wherein the optical system includes a reflective mirror that reflects the reference beams toward the recording medium,
wherein the adjusting unit includes a second moving mechanism, which holds and moves the recording medium, and a third moving mechanism, which moves the reflective mirror, and
wherein the second moving mechanism adjusts a position of the recording medium in an optical axis direction and the third moving mechanism adjusts directions in which the reference beams are reflected.

4. The hologram recording device according to claim 2,
wherein the optical system includes a reflective mirror that reflects the reference beams toward the recording medium,
wherein the adjusting unit includes a second moving mechanism, which holds and moves the recording medium, and a third moving mechanism, which moves the reflective mirror, and
wherein the second moving mechanism adjusts a position of the recording medium in the optical axis direction and the third moving mechanism adjusts directions in which the reference beams are reflected.

5. The hologram recording device according to claim 1,
wherein the optical system includes a relay lens that applies collimated light to an objective lens,
wherein the adjusting unit includes a fourth moving mechanism that moves the relay lens, and
wherein the fourth moving mechanism adjusts a position of the relay lens in an optical axis direction.

6. The hologram recording device according to claim 2,
wherein the optical system includes a relay lens that applies collimated light to the objective lens,
wherein the adjusting unit includes a fourth moving mechanism that moves the relay lens, and
wherein the fourth moving mechanism adjusts a position of the relay lens in the optical axis direction.

7. The hologram recording device according to claim 3,
wherein the optical system includes a relay lens that applies collimated light to the objective lens,
wherein the adjusting unit includes a fourth moving mechanism that moves the relay lens, and
wherein the fourth moving mechanism adjusts a position of the relay lens in the optical axis direction.

8. The hologram recording device according to claim 4,
wherein the optical system includes a relay lens that applies collimated light to the objective lens,
wherein the adjusting unit includes a fourth moving mechanism that moves the relay lens, and
wherein the fourth moving mechanism adjusts a position of the relay lens in the optical axis direction.

9. The hologram recording device according to claim 1, wherein the plurality of laser beam sources include a laser beam source that emits a laser beam of a wavelength corresponding to a color blue, a laser beam source that emits a laser beam of a wavelength corresponding to a color red, and a laser beam source that emits a laser beam of a wavelength corresponding to a color green.

10. The hologram recording device according to claim 2, wherein the plurality of laser beam sources include a laser beam source that emits a laser beam of a wavelength corresponding to a color blue, a laser beam source that emits a laser beam of a wavelength corresponding to a color red, and a laser beam source that emits a laser beam of a wavelength corresponding to a color green.

11. The hologram recording device according to claim 3, wherein the plurality of laser beam sources include a laser beam source that emits a laser beam of a wavelength corresponding to a color blue, a laser beam source that emits a laser beam of a wavelength corresponding to a color red, and a laser beam source that emits a laser beam of a wavelength corresponding to a color green.

12. The hologram recording device according to claim 4, wherein the plurality of laser beam sources include a laser beam source that emits a laser beam of a wavelength corresponding to a color blue, a laser beam source that emits a laser beam of a wavelength corresponding to a color red, and a laser beam source that emits a laser beam of a wavelength corresponding to a color green.

13. The hologram recording device according to claim 5, wherein the plurality of laser beam sources include a laser beam source that emits a laser beam of a wavelength corresponding to a color blue, a laser beam source that emits a laser beam of a wavelength corresponding to a color red, and a laser beam source that emits a laser beam of a wavelength corresponding to a color green.

14. The hologram recording device according to claim 6, wherein the plurality of laser beam sources include a laser beam source that emits a laser beam of a wavelength corresponding to a color blue, a laser beam source that emits a laser beam of a wavelength corresponding to a color red, and a laser beam source that emits a laser beam of a wavelength corresponding to a color green.

15. The hologram recording device according to claim 7, wherein the plurality of laser beam sources include a laser beam source that emits a laser beam of a wavelength corresponding to a color blue, a laser beam source that emits a laser beam of a wavelength corresponding to a color red, and a laser beam source that emits a laser beam of a wavelength corresponding to a color green.

16. The hologram recording device according to claim 8, wherein the plurality of laser beam sources include a laser beam source that emits a laser beam of a wavelength corresponding to a color blue, a laser beam source that emits a laser beam of a wavelength corresponding to a color red, and a laser beam source that emits a laser beam of a wavelength corresponding to a color green.

17. The hologram recording device according to claim 1, wherein the light outputting unit includes
a first optical device that reflects in an optical axis direction a laser beam incident thereon in a first direction and that transmits and outputs a laser beam incident thereon in the optical axis direction,
a second optical device that reflects in the optical axis direction a laser beam incident thereon in a second direction to apply the laser beam to the first optical device and that transmits a laser beam incident thereon in the optical axis direction and applies the laser beam to the first optical device,
a first laser beam source that applies a laser beam to the first optical device in the first direction,
a second laser beam source that applies a laser beam to the second optical device in the second direction, and
a third laser beam source that applies a laser beam to the second optical device in the optical axis direction.
